(19) United States
(12) Patent Application Publication
(10) Pub. No.: US 2005/0069075 A1
(43) Pub. Date: Mar. 31, 2005

(54) Reactor tray vertical geometry with vitrified waste control

(75) Inventor: Hector A. D'Auvergne, San Leandro, CA (US)

Correspondence Address: Harris Zimmerman;Law Offices of Harris Zimmerman, 1330 Broadway, Suite 710, Oakland, CA, 94612, US

(73) Assignee: D.B.I. CENTURY FUELS AND AEROSPACE SERVICES, INC., SAN LEANDRO, CA (US)

(21) Appl. No.: 10/861,776

(22) Filed: Jun. 3, 2004

Related U.S. Application Data
(60) Provisional application No. 60/476,144, filed on Jun. 4, 2003.
(60) Provisional application No. 60/486,877, filed on Jul. 10, 2003.

(51) Int. Cl. G21B 1/00

(52) U.S. Cl. 376/172

(57) ABSTRACT

A nuclear-powered plant for systems of up to about 100 MWs with a confinement section where the reaction takes place in a core having a reactive thorium/uranium-233 composition, and where an external neutron source is used as a modulated neutron multiplier for the reactor core output. The core is housed in a containment structure that radiates thermal energy captured in a multiple-paths heat exchanger. The exchanger heat energy output is put to use in a conventional gas-to-water heat exchanger to produce commercial quality steam.

### RELATED APPLICATION DATA

The present application claims priority under 35 U.S.C. § 119 to U.S. Provisional Application Ser. No. 60/476,144 (Attorney Docket No. DAUVP003P), entitled “DBI REACTOR TRAY GEOMETRY,” naming Hector A. D'Auvergne as inventor, and filed Jun. 4, 2003, the entirety of which is incorporated herein by reference in its entirety for all purposes.

The present application claims priority under 35 U.S.C. § 119 to U.S. Provisional Application Ser. No. 60/486,877 (Attorney Docket No. DAUVP004P), entitled “DBI TRAY REACTOR,” naming Hector A. D'Auvergne as inventor, and filed Jul. 10, 2003, the entirety of which is incorporated herein by reference in its entirety for all purposes.

### FIELD OF THE INVENTION

The present invention relates to a nuclear reactor fueled by thorium-232/uranium-233 (²³¹Th/²³³U) and driven by an exterior source of modulated neutrons. The criticality and power output of a graphite-reflected fuel cage and design concept is based on a subcritical assembly, where the thermal output is established on a per-unit neutron source basis, and as such can be used to determine the source strength required to obtain a desired power level, or for a given source strength to predict power level. This application includes the fundamentals of fuel management issues, such as cycle length, breeding ratio, fuel depletion, or the production and buildup of fission products. All calculations were performed by the MCNP neutron transport code developed at Los Alamos National Laboratory. MCNP is a Monte Carlo radiation transport code that has gained international acceptance and is widely considered the standard for performing calculations of this type.

### BACKGROUND OF THE INVENTION

Worldwide petroleum reserves needed to fuel power plants, a growing vehicle fleet, and an industrial economy are nearly depleted. Currently, the U.S. imports a large percent of its petroleum from politically unstable locations. Additionally, alternative energy technologies—such as solar, wind, and geothermal—are losing governmental support. Indeed, the U.S. appears to be heading toward another energy crisis due to governmental policies, public pressure, utility company shortsightedness, and corporate lack of incentives to either use alternative energy technologies or conserve energy.

In addition, the U.S. is confronted with environmental safety matters when using any sort of energy-generating method, whether a coal-fired plant or a solar plant. Environmental concerns range over a wide array of atmospheric, ground, and water pollution impacts.

The search for clean, safe forms of energy generation has taken many paths. Fusion—the union of two or more atoms into a single atom, with a simultaneous release of energy—has the promise of being a clean, cheap, and virtually limitless source of energy. Hot fusion (at elevated temperature) has been under intense investigation since the 1940s, though the scientific community doubts cold fusion (at room temperature) could be sustained or be useful as a stand-alone source of energy (Science News, vol. 137, 7 April 1990 and 16 Jun. 1990). An isolated and unsubstantiated laboratory experiment showed a slim possibility that fusion could be developed through relatively simple means at room temperature (Pons, B. Stanley, and Martin Fleishmann, University of Utah, 23 Mar. 23, 1989), but other experimental efforts to achieve such fusion have not been sustained. However, many decades are still required to overcome the scientific and technological obstacles that prevent hot fusion from becoming a safe and affordable method of generating energy.

The nuclear power industry was born in the 1950s with great promise as an energy source that would solve all future energy problems. In the 1970s, dreams of energy surpluses based on nuclear power soon turned into energy shortages, followed in the 1980s by a glut that clouded the energy issue. Over the years, the nuclear industry has attempted to push ahead with vast, costly projects that carry with them an array of human health and environmental safety risks. These costs and risks have stunted the industry's growth: while world nuclear generating capacity grew by 140% in the 1980s, it expanded by less than 5% in the 1990s. And proposed new construction will continue to result in the political opposition and public pressures that have blocked previous construction and stifled the industry's growth.

But, conventional nuclear power has serious drawbacks. Specifically, production of a vast amount of extremely dangerous radioactive waste and lack of space for its disposal, potential for a meltdown that could release radioactivity, a byproduct that can be used for manufacturing nuclear weapons, and enormously high costs. These drawbacks will continue to plague the industry, since conventional reactors will have produced enough waste within 10 years to completely fill the proposed waste storage site at Yucca Mountain, and require the use of uranium and the manufacture of weapons-grade plutonium.

Historically, neither thorium oxide nor thorium metal has by itself been part of the fuel loading of any conventional reactor built or operating in the U.S. Thorium has been used in blankets in several reactors around the world as a means to capture free neutrons wandering in the reactor vessel, at a neutron flux (volume of neutron production) of 10¹⁴, to produce fissile material. What normally comes out of said blanket is ²³³U that can be used to enrich low-grade plutonium, thereby increasing the life span of ²³⁸U. To our knowledge, only one reactor has been proposed—in India—that intended to use thorium as a main source of fertile material. The proposal assumed at that time that the government would have reprocessing available to remove the useable ²³³U from the waste stream. These reactor plans, however, have been abandoned.

Thorium cannot be part of a conventional reactor without increasing the volume of waste disposal. Substantial studies and proposals have been done in this country. None of them have been carried forward, though, because the burnout rate of the thorium in conventional reactors is no different than that of plutonium, which calls for a large reprocessing plant. The U.S. presently does not have means of reprocessing fuel, with the exception of some enrichment facilities for the defense mechanism. Without the reprocessing plant, the large volume of unburned ²³³U, with its high gamma emissions, must become part of the waste stream.

Since current conventional energy-generating sources present grave hazards to public safety, health, and psychological well being, U.S. citizens are demanding a clean, safe, and domestically-produced energy source. However, the most viable alternatives—hydrogen and electricity—are not energy sources but rather energy carriers that require a source of energy to start.

### SUMMARY OF THE INVENTION

DBI's report Thorium to Hydrogen (Library of Congress Control Number 2003097825) shows the limitations of current sources of energy, including fossil fuels, solar cells, ocean energy, hydroelectric dams, and wind turbines. Although nuclear energy has not been promoted as an alternative due to the human health and environmental safety risks associated with current reactor designs, the reactor of the present invention drastically reduces—if not eliminates—many of the dangers associated with conventional nuclear reactors.

The present invention is a nuclear reactor that uses ²³²Th as fuel and adds neutrons from an external source—rather than through criticality—to transmute the ²³²Th into ²¹¹U. This reaction will create heat energy through controlled nuclear fission occurring in confinement, and can be used for systems of up to about 100 MWs. The thorium fuel design of the present invention can also be used economically as an energy source for systems of less than 1 MW.

One of the most prominent aspects of the present invention is the fuel system. The unique design of the present invention allows for a fuel burn-up rate of about 90%, reduces the amount of waste by about 90% from current reactor designs, and produces no weapons grade material. When compared to conventional uranium-based nuclear reactors, the thorium design concept of the present invention eliminates the current problems of high waste production, negative environmental impact, proliferation of nuclear weapons material, reactor instability with possibility of meltdown, system complexity, and high operating costs. The present invention may be used in any application which uses a heat source to generate steam for a thermodynamic cycle (such as driving turbines) to generate electricity, pump water, or extract hydrogen.

With a single-phase helium coolant, a graphite moderator, and carbon reflectors, the present invention uses a multiple cavity fuel element, with fuel in the form of thorium oxide and glass in pre-baked tablets containing 50% SiO₂, 47% ²³²ThO₂, 3% ²³³UO₂ in some configurations. A 90% burn rate is possible because the present invention allows the fuel to remain in the core until it is totally burned, something not possible in conventional reactors. In a shutdown mode, the fuel of the present invention is solid vitrified matter, providing an impervious, tamper-proof container for the spent fuel. This design is fundamentally different from conventional reactor core designs in multiple ways. The reactor of the present invention is subcritical, meaning it does not rely on a critical reaction to achieve the necessary neutrons. An external source of modulated neutrons makes possible the operation of the present subcritical reactor invention by an external neutron flux supply to bring the system up to a k=0.98 status in a safe and controllable manner. The neutron flux can be instantly stopped, controllably altered to new flux levels, or run at any neutron flux level needed, until the reactor of the present invention through fuel breeding develops its own ability to control power levels. The amount of breeding determines the neutron output flux level, and thereby the source can be slaved to the present invention's power level to maintain the exact power level desired, without fear of major core excursions.

The reactor of the present invention does not rely on direct forced cooling of the core fuel elements to slow the reaction process. Neither does it depend on primary liquid coolant loops directly in contact with the fuel bundle, nor any of the equipment normally used to extract the thermal energy from the neutron activity. Heat is extracted from the present invention without direct contact between the coolant and the fuel source.

The present invention can be designed in a variety of sizes, ranging from as small as about 1 MW to more than about 100 MWs. This application contains one of multiple possible geometric designs in which the fuel can be switched from well to well. The attached figures represent a few specific embodiments for about a 100-MW plant. The power output, incidentally, will determine the physical size of the plant. The design allows it to be installed only about 18 feet below grade, thus eliminating the need to rely upon geological proof of deep ground stability.

The reactor of the present invention uses thorium as the energy source, which can then be used for the production of hydrogen—as a bridge from oil to fusion—while simultaneously reducing the volume of fuel loading and unburned fuel content using a new geometry for nuclear reactors. It can produce energy to extract hydrogen economically, with a significantly reduced amount of waste—all vitrified and containing only a minimal presence of useable ²³³U. The present invention provides maximum safety for startup, operation, and nuclear waste disposal. It is also innovative in its promotion of safety in connection with fueling startup, operation, shutdown, refining, and waste disposal. The configuration disclosed meets all the design performance requirements of simplicity, safety, reactor lifetime, reactor power output control, and economy of low investment and operational cost.

A great deal of careful scrutiny by technical minds in many fields has provided assurance that the concept is important, feasible, and within the present state of the art. The safety aspects of the design warrant support for a continued detailed effort coupled to the development of the first thorium-to-hydrogen 100-MW commercial installation.

### BRIEF DESCRIPTION OF DRAWINGS

The assembly of the present invention has other objects and features of advantage which will be more readily apparent from the following description of the best mode of carrying out the invention and the appended claims, when taken in conjunction with the accompanying drawing, in which:

FIG. 1 is a top plan view of an external neutron source drum formed by multiple plates, as constructed in accordance with the present invention.

FIG. 2A is a to perspective view of a thorium/glass fuel disk with built-in glass spacers.

FIG. 2B is a top plan view of a fuel disk of FIG. 2A.

FIG. 2C is a side elevation view taken along the plane of the line 2C-2C in FIG. 2B, and illustrating the high-porosity center (and “V” channels in some configurations).

FIG. 3 is a top perspective view of a vertical fuel well cavity generated by stainless steel plates.

FIG. 4 is a top perspective view of a fuel stack with carbon spacers on both ends and boron “poison” disks among the fuel disks.

FIG. 5 is an exploded top perspective view of the fuel stack with steel rack that has holes for xenon bleed.

FIG. 6 is a top perspective view of a boiler assembly constructed in accordance with the present invention.

FIG. 7 is an exploded, top perspective view, partially broken away, of a reactor assembly of the present invention with a single neutron emitter with a heat exchanger and a barrier, in one specific embodiment, and showing the silhouettes of surrounding boiler wells.

FIG. 8 is an exploded, top perspective view of another specific embodiment of an alternative embodiment reactor assembly with a single neutron emitter with a heat exchanger, fuel cavities, and a second barrier for multi-fuel assembly.

FIG. 9 is a top perspective view of another specific embodiment of a reactor assembly with dual neutron emitters.

FIG. 10 is a top perspective view of the reactor assembly of FIG. 9.

FIG. 11 is an exploded, top perspective view of the reactor assembly of FIG. 9, at grade level with a control system area and gravity feed emergency shut down absorber.

FIG. 12 is another exploded, top perspective view of the reactor assembly of FIG. 9.

FIG. 13 is a top plan view of yet another specific embodiment of the reactor assembly, having a three-drum assembly for larger MW installations.

FIG. 14 is a flow chart diagram illustrating the kinetic stages and control of the reactor assembly of the present invention.

FIG. 15 is a flow chart diagram illustrating a modified neutron life history for the reactor assembly of the present invention.

FIG. 16 is a table of induced fission in ²³²Th cumulative yield.

FIG. 17 is a table of induced fission in ²³³U cumulative yield.

FIG. 18 is a graph of a fission products (isotopes) monitoring schedule in water and in cement.

FIG. 19 is a fuel cycle comparison of the reactor of the present invention to a conventional reactor.

FIG. 20 is a graph a fission cross section as a function of neutron energy for ²³³U.

### BRIEF DESCRIPTION OF COMPONENTS

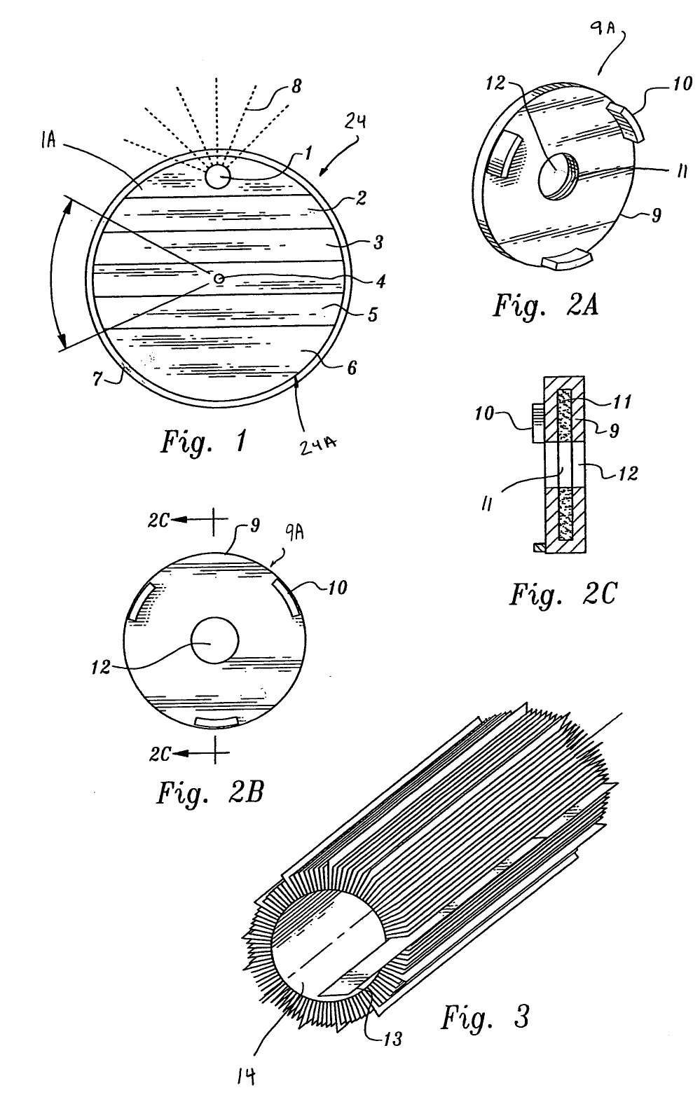

Component #1—neutron emitter well consisting of the element californium
Component #1A material suitable to cradle the neutron emitter
Component #2—steel plate component of
Component #3—steel/carbon plate partial reflector
Component #4—body and center of rotation
Component #5—steel/boron plate assisting neutron emission direction by absorption
Component #6—high-density steel/boron plate to stop reverse neutron traffic
Component #7—steel emitter sleeve inside which the neutron source drum rotates
Component #8—available neutron direction
Component #9—glass casing for fuel disk assembly consisting of 50% glass and 47% ²³²Th in some configurations
Component #9A fuel disk assembly
Component #10 glass fuel disk spacers
Component #11 high-porosity embodiment of thorium and glass that allows xenon to bleed out helium path for xenon removal
Component #12A —steel tube to hold fuel stack
Component #12B —steel disk to hold fuel stack in place
Component #12C —holes to allow xenon bleed
Component #13 stainless steel plates or “V” channels that generate a well for fuel disks
Component #14 fuel disk well generated by stainless steel plates
Component #15 carbon spacers (at top and bottom)
Component #16 stack of thorium/glass fuel disks, where height and diameter are determined by computer Component #10 program as a function of the reactor size
Component #17 boron “poison” disks to allow more fuel to be present at the core, thus controlling burning Component #10 levels and thereby output
Component #18 boiler drum of ASME-approved pressure vessel
Component #19 Chevron steam dryer to avoid turbine blade damage
Component #20 ASME-approved boiler tubes
Component #21 heat exchange medium inlet
Component #22 heat exchange medium outlet
Component #23 neutron emitter cooling tubes
Component #24 single neutron emitter assembly
Component #24A drum assembly
Component #25 cadmium thermal neutron barrier required for certain reactors, dictated by neutron transport computer program used for a given installation
Component #26 cadmium thermal neutron barrier
Component #27 neutron emitter assembly fuel wells (white denote empty fuel wells 47, dark denote wells containing fuel stacks 46)
Component #28 individual fuel stack cadmium neutron barrier, needed in some configurations
Component #29 ASME-approved pressure vessel ring
Component #30 boiler wells
Component #31 boiler well wall generated by steel sheets
Component #32 emergency shut down boron absorber well
Component #33 emergency shut down boron absorber sleeve
Component #35 cadmium thermal neutron barrier
Component #36 granulated graphite neutron moderator to allow reactor assembly thermalize (slow to below 1 MeV)
Component #37 neutron emitter coolant tubes
Component #37A —reactor coolant tubes
Component #38 boron emitter neutron absorbers to further encourage one direction of emission of neutron source
Component #40 ASME standard mandate vessel wall
Component #41 lead wall
Component #42 steel/boron wall
Component #43 thermal insulation, includes an air gap to reach about 70° F. skin temperature
Component #44 ASME-approved pressure vessel assembly lower ring
Component #45 granulated carbon reflector, with copper to heighten thermal conductivity
Component #46 fuel well occupied by a fuel stack assembly
Component #47 empty fuel wells that allow fuel to remain at the core, and let heat contribution dictate position of the neutron-emitting well in FIG. 1
Component #48 neutron emitter drum driver (an electrically-driven gear box) sets position of neutron emitter for maximum temperature desired, driven by core temperature data
Component #49 cement structure
Component #51 fuel stack assembly
Component #52 emergency gravity feed boron absorber to shut down reactor in case of grid failure
Component #53 ASME-approved boilers
Component #54 Controls system area, consisting of three banks of computers and up to two discriminators that trigger a warning system through a dedicated satellite communication line
Component #55 below grade cement structure
Component #56 ground
Component #60 reactor assembly

### DETAILED DESCRIPTION OF THE INVENTION

While the present invention will be described with reference to a few specific embodiments, the description is illustrative of the invention and is not to be construed as limiting the invention. Various modifications to the present invention can be made to the preferred embodiments by those skilled in the art without departing from the true spirit and scope of the invention as defined by the appended claims. It will be noted here that for a better understanding, like components are designated by like reference numerals throughout the various figures.

In accordance with the present invention, some of the fundamental ideas of the reactor of the present invention are: (1) to drastically reduce the danger and the volume of nuclear waste; (2) to drastically reduce the size of the fuel charge in a reactor; (3) to eliminate weapons material in the waste stream; (4) to eliminate the need for reprocessing of nuclear fuel; and (5) to create a scenario where thorium will provide all U.S. electrical energy for the next 250 years. While the details set forth in this application make a complete disclosure of the invention, numerous changes may be made in such detail without departing from the spirit and principles of the invention.

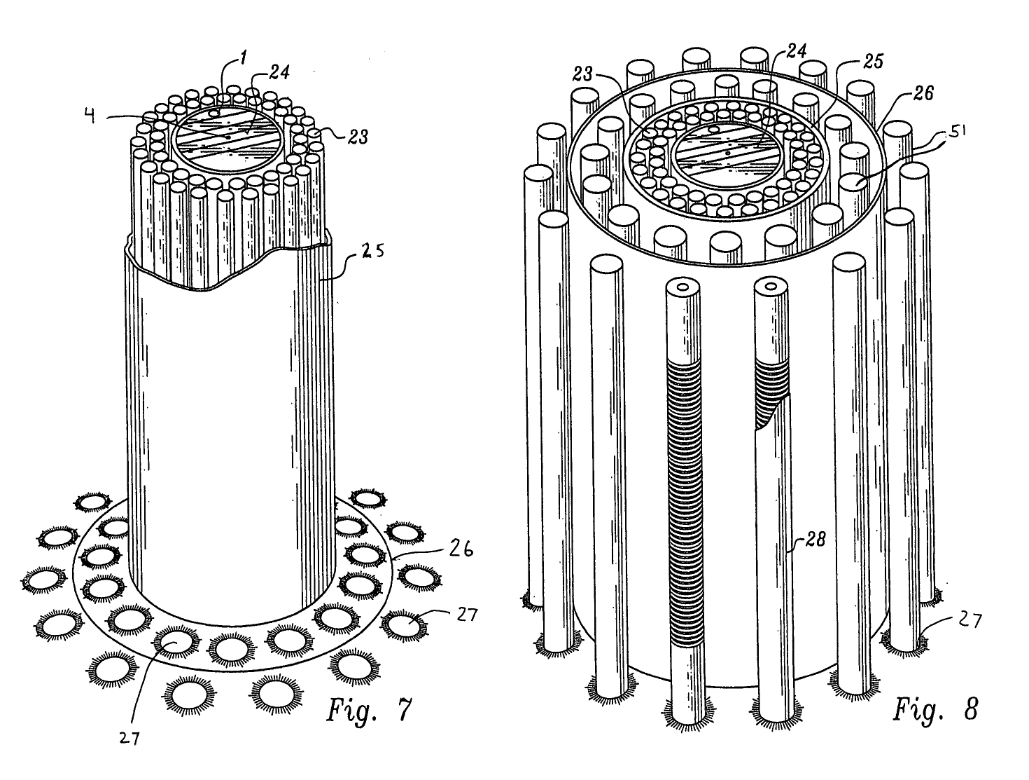

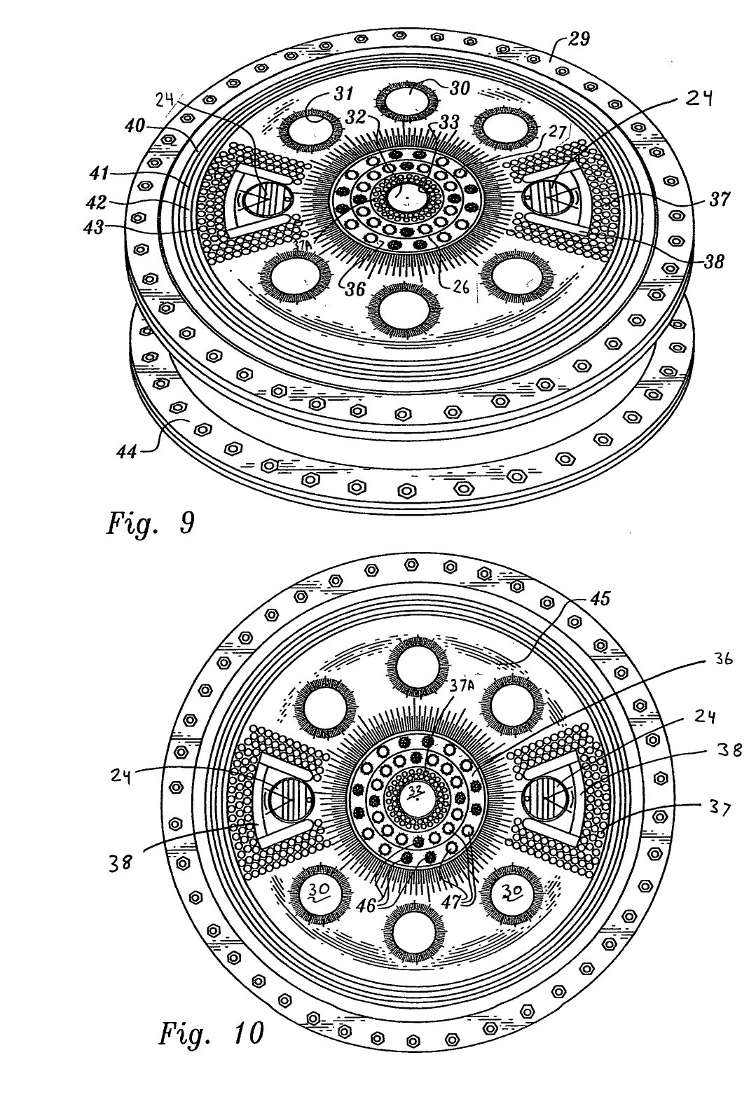

The reactor of the present invention, in one embodiment, uses a single external source of neutrons coming from an emitter assembly 24 shown in FIG. 1, and in more detail in FIG. 7 and FIG. 8. A larger installation can be achieved through a dual neutron emitter assembly 24 (FIG. 9, FIG. 10) or a triple neutron emitter assembly 24 (FIG. 13). Even larger installations can be achieved using additional neutron emitters. The neutron source drum 24A consists of a neutron emitter 1 surrounded by any material casing 1A suitable for its cradling, and formed into a drum formed using a plate of steel 2, a plate of steel/carbon 3, another plate of steel/carbon 3, a plate of steel/boron 5, and a high-density plate of steel/boron 6. The neutron source drum is housed in a steel sleeve 7. The plates form a neutron shielding and absorber, forcing a specific neutron direction 8.

The neutron source, in one configuration, is the element californium, which has the ability to produce a neutron flux of 10¹¹. In other configurations, the modulated neutrons are derived from a source of protons coming from a linear accelerator, also producing a flux of 10¹¹. In the first source, the assembly rotates on an axis 4 and provides or deprives neutrons to the fuel assembly. If the neutron source is a linear accelerator, the neutrons are provided or deprived by the modulation of the proton source. Either source of neutrons serves as neutron modulation to the location of fuel wells 27, shown in FIG. 9 and FIG. 10. This approach, as well as other components described below, are better described in our U.S. patent application Ser. No. 10/786,530, filed Feb. 24, 2004, and entitled “NEW REACTOR GEOMETRY AND DRY CONFINEMENT FOR A NUCLEAR REACTOR ENABLING THE RACQUETBALL EFFECT OF NEUTRON CONSERVATION DRY CONFINEMENT TO BE SUPPORTED BY THE FOUR-FACTOR AND SIX-FACTOR FORMULA, herein incorporated by reference in its entirety.

Flux of Particles from an Accelerator. The neutron flux from the particle accelerator is in the range of about 10¹¹; energy is in the 6 MeV range. A number of accelerators can be used to achieve the end result. The present invention incorporates a modified one of those accelerators by reducing its physical size, since the proton source—and thereby the resulting output in neutrons—is reduced to one assembly.

Flux of Neutrons from ²⁵²Cf. The neutron production rate of californium is 2.3×10¹² neutrons/second/gram. The material element has a half-life of 2.645 years and decays by alpha emission (96.9%) or spontaneous fission (3.1%). Gamma dose is typically an order of magnitude less than the neutron dose. One milligram of ²⁵²Cf emits 2.3×10⁹ neutrons/s, with an average neutron energy of 2.1 MeV, and up to 10¹¹ neutrons/s from a single source (5 cm×1 cm). One of the most attractive aspects of the material is that its most probable energy is about 0.7 MeV, which is in the range of thermal neutrons. Thus the use of californium means a considerably smaller amount of x-rays will be produced, resulting in a much smaller quantity of thermalization material needed.

The reactor of the present invention relies on a fuel element 11 (FIG. 2A, FIG. 2B, FIG. 2C) composed of 50% SiO₂, 47% ²³²ThO₂, 3% ²³³UO₂ in some configurations. The fuel element 11 is pre-baked in a kiln at 2200° F. for 10 minutes, where baking (melting) time is a function of the fuel element thickness, and encased in glass casing 9. A non-encased center opening 12 exposing the high-porosity fuel embodiment of thorium and glass 11, combined with the glass spacers 10, creates a pathway for the bleeding out of the fission byproduct xenon. The diameter of the fuel element is a function of the reactor size.

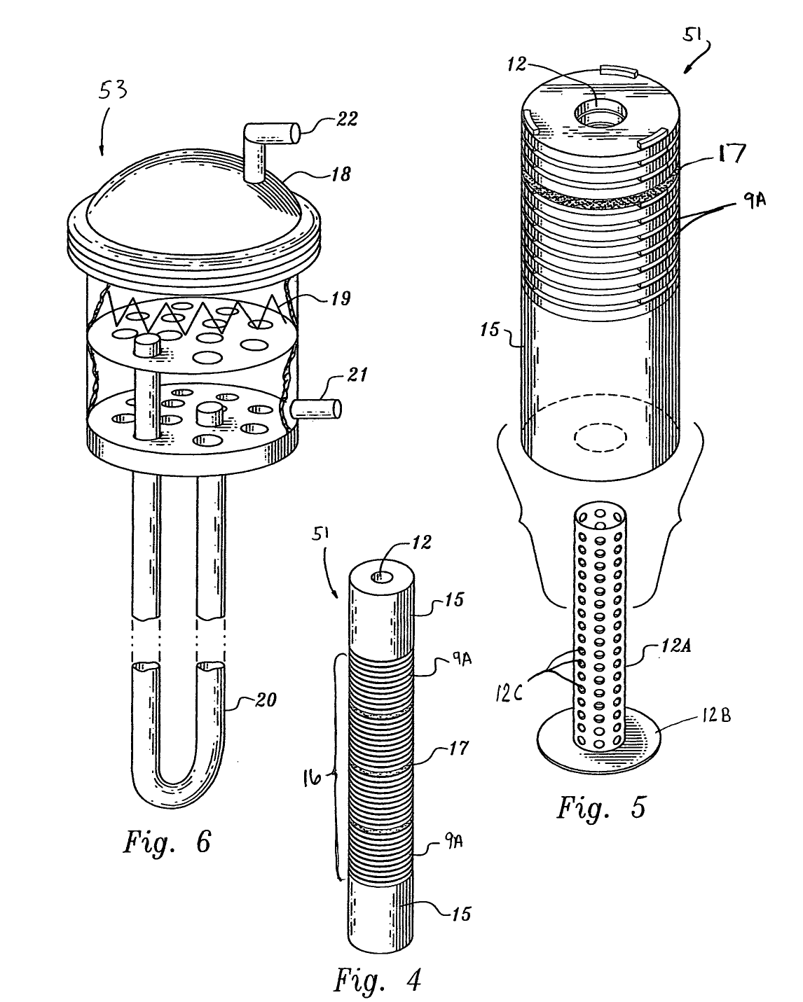

The fuel elements 11 are stacked atop each other (FIGS. 4-5), forming fuel stack 16, with the height of the stack a function of the reactor size. Interspersed among the fuel elements are boron elements 17 that allow the presence of more fuel at the core, thus controlling burning levels and thereby output. The boron elements are eventually burned-up during operation. The entirety of the fuel stack includes carbon spacers 15 at the top and bottom of stacked fuel elements, with the height of the carbon spacers determined by the thickness of the reactor shielding. The fuel stack 16, boron elements 17 and spacers 15 are placed around a steel tube 12A, forming a fuel stack assembly 51 that contains numerous holes 12C to permit the bleeding of the xenon into the helium path for xenon removal. A solid steel disk 12B serves as a base to hold the fuel stack. Fuel stack assembly 51 in some configurations are surrounded by a cadmium barrier 28 (FIG. 8), which thermal (slower than 1 MeV) neutrons may not penetrate. The thermalized neutrons coming from the fuel well 27, 46 allow the transmutation of ²³²Th through proctanium for the production of fissile ²³³U in situ. The thermal neutron region is continuously receiving fast neutrons (above 1 MeV) from adjacent fuel charges.

The xenon removal pathway through center opening 12 of the fuel stack assembly 51 will connect to standard piping (not shown) through which helium transports the xenon and directs it to a conventional xenon separator.

As shown in FIG. 3, inconnel steel plates or “V” channels 13 arranged in a circular pattern generate fuel well cavities 14 which ultimately comprise fuel well 27. The fuel wells 27 are situated around the neutron source emitter 24 as shown in FIG. 7 and FIG. 8 for a single neutron emitter assembly 24. Similarly, the fuel wells 27 for dual neutron emitter assemblies 27 for a larger installations, shown in FIGS. 9 and 10, are situated around the neutron source emitters 39. The fuel wells 27 are embedded in a granulated graphite moderator 36 to slow neutrons faster than 1 MeV emanating from the neutron source emitter.

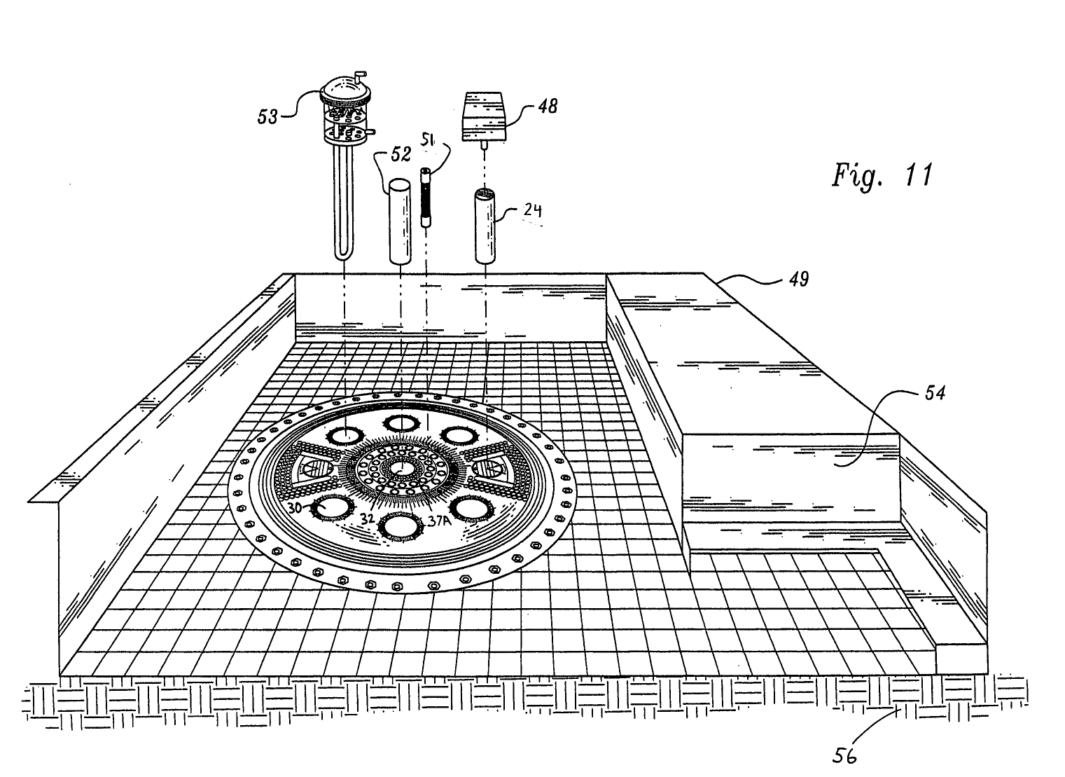

A cadmium neutron barrier 25, 26 surrounds each circle of fuel wells 27, as shown in FIGS. 7-8 and FIGS. 9-10, respectively. The center of the fuel well array in the dual neutron assembly is an empty absorber well 32 which is configured to accept an emergency gravity feed boron assembly 52 (FIG. 11) that will shut down the reactor of the present invention in case of grid failure. The absorber well 32 is defined by a steel sleeve 33. Surrounding the emergency shut down boron absorber well steel sleeve 33 are reactor coolant tubes 37A. Helium or other suitable material can be used as coolant.

The outer cadmium barrier 26 sits inside a fuel well array cavity well generated by steel plates. The cavity well is embedded in a granulated carbon reflector 45 containing copper to heighten thermal conductivity. Also embedded in the reflector 45 are boiler wells 30 generated by Inconnel steel walls 30, 31. Granulated carbon with aluminum conductors will fill the boiler wells 30, with ASME-approved boiler assembly (FIG. 6) embedded.

Neutron source emitters are surrounded by coolant tubes 23 which are composed of ASME-approved material. The neutron source emitters 24 in the dual emitter assembly are surrounded by boron neutron absorbers 38 to further encourage one direction of neutron emission.

The entire reactor assembly 60 of the reactor of the present invention is surrounded by a thermal insulation barrier 43 to lower the vessel's surface temperature. The insulation contains additional allowances for potential fugitive emissions and is housed in walls 41, 42 of lead, steel, and boron. The assembly 60 is encased in an ASME-approved outer pressure vessel assembly 40 of clad (low-carbon) steel. The vessel assembly 40 includes an upper ring 29 and a lower ring 44, as best viewed in FIG. 9.

During startup—which involves emitting neutrons—some of the fuel wells 27, 47 are empty. When the fuel charge or fuel stack assembly 51 in a well 27, 46 is declining in power, there is time to switch it to the first empty well 27, 47; a new or partially new charge 51 is then placed in the emptied well. At the second startup, there will be an excess of power. At this time the modulation of neutrons takes place by either rotating the drum 24A with californium on its axis 4, or modulating the source of protons coming from a linear accelerator. When the neutron source is not enough to support total power, the third startup will occur. At this time, it is necessary to switch the last charge to the next empty well, and replace it with a new charge. The desired position is dictated by a geometrically-balanced neutron transport computer program as case history is gradually obtained. An excess of power at the third startup is again controlled by the modulation of the neutron source. When the modulation reaches the maximum, fuel charges are again moved to new wells.

This process continues until all the original empty wells are filled. This is when the first charge, from the original first empty well, is removed for disposal. At this time, the charge will have a potential burn-up of about 90% of the fuel, since a continuous removal of xenon (a byproduct that absorbs otherwise useable neutrons) has taken place. The continuous removal of xenon takes place at the fuel charge 12 during its tenure at the core. Again, this process and apparatus are better described in our U.S. patent application Ser. No. 10/786,530, cited above, which is herein incorporated by reference in its entirety.

At the time the first charge is removed, no weapons material is present in the waste stream. Since the composition of the first load of waste is vitrified, the burned out fuel elements are placed in water for 36 months. Once cold, they will contain short-lived isotopes whose half-lives range from a few hours to 28-29 years (strontium-90 and cesium-137), and long-decaying isotopes whose half-lives range from 1.1×10⁶ to 2.6×10⁶ years (zirconium-93 and cesium-135), as shown in the chart of FIG. 18. These materials are vitrified in situ and will remain encapsulated in glass during their entire decay process, never reaching underground waterways by moisture leakage or rainfall since glass will be providing the barrier over the years.

Thermalized neutrons cause nuclear fission within the fuel, with heat energy the primary byproduct. The heat energy at the core is transferred by conduction from the core through to the boilers, where the temperature differential is very high. The heat transfer media is conventional and not limited to helium. In order to generate 1 megawatt-day [MW-d] of heat energy, 3.3×10¹⁰ [fissions/s] is needed, or about 1 gram of ²³²Th/²³³Uto burn (1.15741×10⁻⁵ grams of thorium per second). Most of this energy is dissipated as heat within the reactor. Traditionally, the amount of neutrons needed for breeding approximates 10¹⁴ n/cm₂.

After thermalization of fast fission neutrons in the graphite moderator 36, ²³³U is produced in the chain reaction following thermal neutron capture in ²³²Th. Although fast neutron capture in ²³²Th resonances is also possible, the ratio of resonance to thermal absorption is 0.13. Nuclear reactions under thermal irradiation of ²³³U are available. The amount of isotopes produced depends on the neutron flux as well as the time of irradiation. For example, 1 gram of ²³³U will be produced per kilogram of ²³²Th after 20 days of ²³²Th irradiation with neutron flux of 10¹⁴ n/cm₂.

Representative Distribution of Fission Energy

| | Fission | Heat Prod. | % of |
|---|---|---|---|
| Energy Source | Energy (MeV) | (MeV) | Total |
| Fission fragments | 168 | 168 | 84 |
| Neutrons | 5 | 5 | 2.5 |
| Prompt gamma rays | 7 | 7 | 3.5 |
| Delayed radiations: | | | |
| Beta particles* | 20 | 8 | 4 |
| Gamma rays | 7 | 7 | 3.5 |
| Radioactive capture | — | 5 | 2.5 |
| of gammas** | | | |
| Total | 207 | 200 | 100 |

*Includes energy carried by beta particles and antineutrinos; the latter do not produce heat in reactor systems.
**Nonfission capture reactions contribute heat energy in all real systems: design-specific considerations may change this number by about a factor of two in either direction.

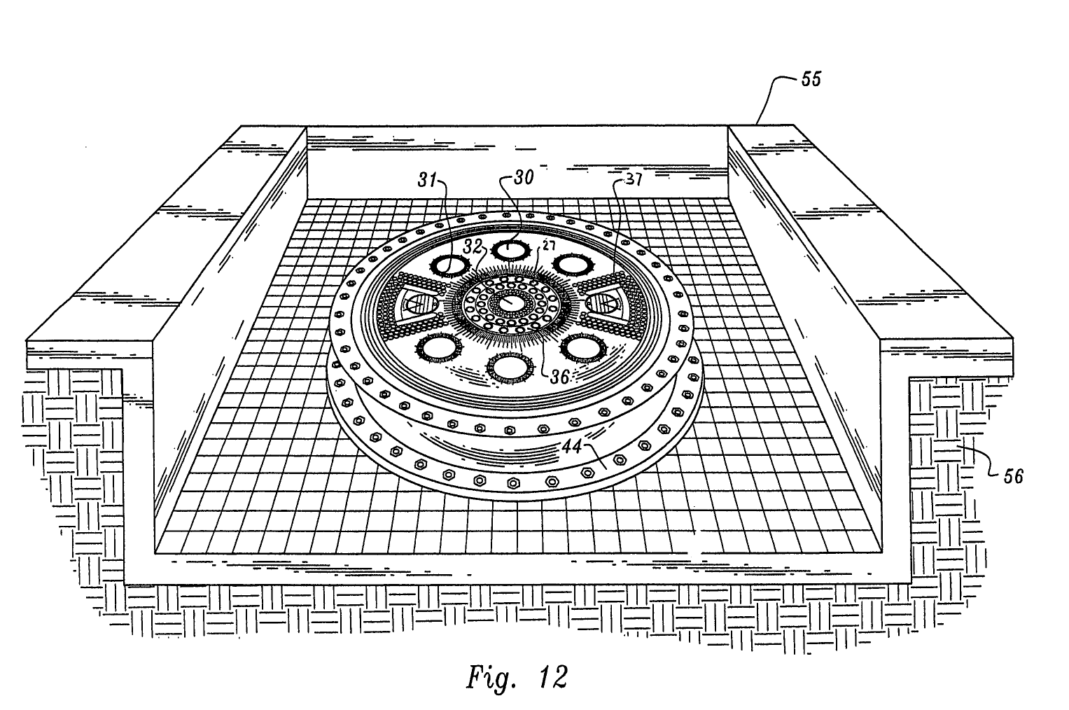

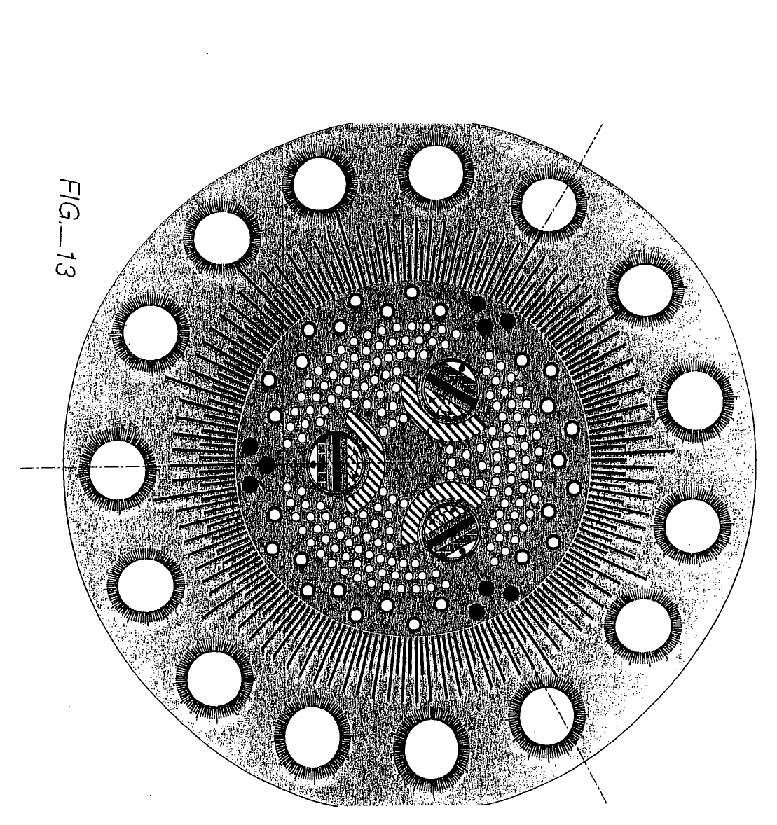

In the embodiments illustrated in FIGS. 11 and 12, about a 100-MW thorium reactor is illustrated with reactor height approximately ten feet and diameter approximately 30 feet underground, creating a shallow underground installation geared to the production of hydrogen. The reactor of the present invention would not require complex control systems but would emphasize the avoidance of complex fuel processing. Following is the route to the 100-MW reactor of the present invention, beginning with the fundamentals involving the ¼-to 2-MW demonstration plant mounted in a trailer.

Reactor Confinement. The solid confinement consists of multiple segments (40-43), where allowances are made for expansion and contraction of the reactor assembly 60. The design compensates for neutron flux of various magnitudes that call for thermal excursions in the core. The segment “blocks” consist of Inconnel mesh and carbon. Conventional reactors use stainless steel containers to house their spent fuel rods, and stainless steel requires vast quantities of nickel—needed in many other industries—to slow down oxidation. In contrast, the reactor of the present invention uses primarily expanded Inconnel. Although Inconnel contains a higher percentage of nickel than stainless steel, the expanded version is one that has been stretched into a thin open weave similar to chicken wire. This still holds the fuel in place, but uses far less metal, including nickel.

The fuel elements 9A (FIGS. 2A-2C, and 4) are sufficiently porous to allow for the bleeding of emission gases. The position of these bleeders is critical, since these gases are neutron absorbers. These bleeders (poison disks 17) are strategically placed where the neutron flux consists of neutrons of a specific energy. At the regions where fast neutrons exist, neither gas nor any other fission product has a major poisoning influence on the core. The inner gap blocks, therefore, constitute an important feature to reach maximum neutron economy. Venting gases that are potential neutron absorbers are very important. The solid state components of this invention are placed in proper position, both mechanically for continuous maintenance and nucleonically to maintain proper geometries.

Moderator. The neutron moderation is there to create enough thermal neutrons, out of fast neutrons, for breeding purposes. The difference between a standard reactor and the reactor of the present invention, in this respect, is the volume of neutron production (neutron flux). The reactor of the present invention relies heavily on neutron economy. The neutron confinement allows the reduction of losses in contrast with conventional reactors of equal output. In the containment being used, the theoretical leakage is nil and control of over-population by absorption (control rods) is nonexistent, since the reactor operates below k=1. In this subcritical state, the neutron population is a direct function of the beam input and control rods are not necessary. The reactor assembly 60 of the present invention is producing only the neutrons needed for a specific output, in contrast with standard reactors that must produce substantial additional neutron flux for a given output.

Reflectors. Structurally, the reflector 36 (FIG. 9) is the simplest part of the reactor of the present invention. Made of carbon, its shape provides for what the company has termed the “Racquetball Effect.” This occurs without changing peak power, but affects power density at the reflection region. As a result, the core power increases by 40%-45% by virtue of a neutron economy, while gradually decreasing the flow of neutrons from the multiplier. In conventional reactors, Hot-Spot Factors involve the maximum value of F_{Q}, which identifies the maximum local power density or linear heat rate. In those reactors, a substantial amount of waste neutrons must be produced and subsequently eliminated in order to maintain power density stable enough for a steady state of commercial steam production. This contrasts with the reactor of the present invention, where the reflector is able to reflect back the amount of neutrons needed for a specific output. This feature allows for power settings using only needed neutrons and not excess neutrons.

Boilers & Preheaters. The boilers 53 are full surface-to-heat transfer modified ASME-approved hairpin boilers. The pipe schedule complies with the ASME code. This alloy also serves as the first gamma attenuator, and as a heat-transfer medium operating at a high-temperature differential. The preheaters are built within ASME code, embedded in aluminum/cast iron. This alloy also serves as the second gamma attenuator blocker and as a heat-transfer medium.

Outer Gap. This is a stainless steel spacer embedded in a clay mixture, a pliable medium to deal with thermal expansion during core excursions. Additional gamma safeguard attenuator blockers are part of this area that further allows the reactor of the present invention to temporarily shut down without gamma emission.

Feed Water Pumps. In one embodiment, the feed water pump system consists of a bank of four positive displacement pumps. The pumps are bypassed, allowing each pump to operate in around-the-clock intervals, pre-determined by the pump manufacturer. Allowances have been made for the operator to be able to remove a pump and replace it without shutting down the flow. The pumps operate within a strict schedule of maintenance. Electrical and mechanical malfunction sensors are provided for each pump.

Water Quality Control. The water quality control is achieved with a standard softener, Ph control, and conventional additives to meet corrosion allowances specified by ASME Code.

Condensers. The steam condensing takes place in a bank of four air-to-steam heat exchangers. The physical size of the condensers' surface area changes between the two cycles proposed. One of the cycles cuts down the volume of water by operating the power recovery in the left-hand side of the T/S diagram. The idea is to move away from the saturated, liquid side of the diagram, thus allowing the volume of water to be reduced. This cycle uses a vapor compressor instead of feed-water pumps.

Controls. The reactor of the present invention incorporates a drastically simplified system of control, since the core temperature sections are built in the assembly and have the potential to provide a high level of safety without relying on containment or mechanized support to control LOCA or similar emergencies. The proposed Control Area 54 for a 100-MW plant consists of a bank of three sets of three computers each and up to two discriminators with flat screen monitors in the wall. The warning system is based upon a series of sensors connected to a dedicated satellite communications line.

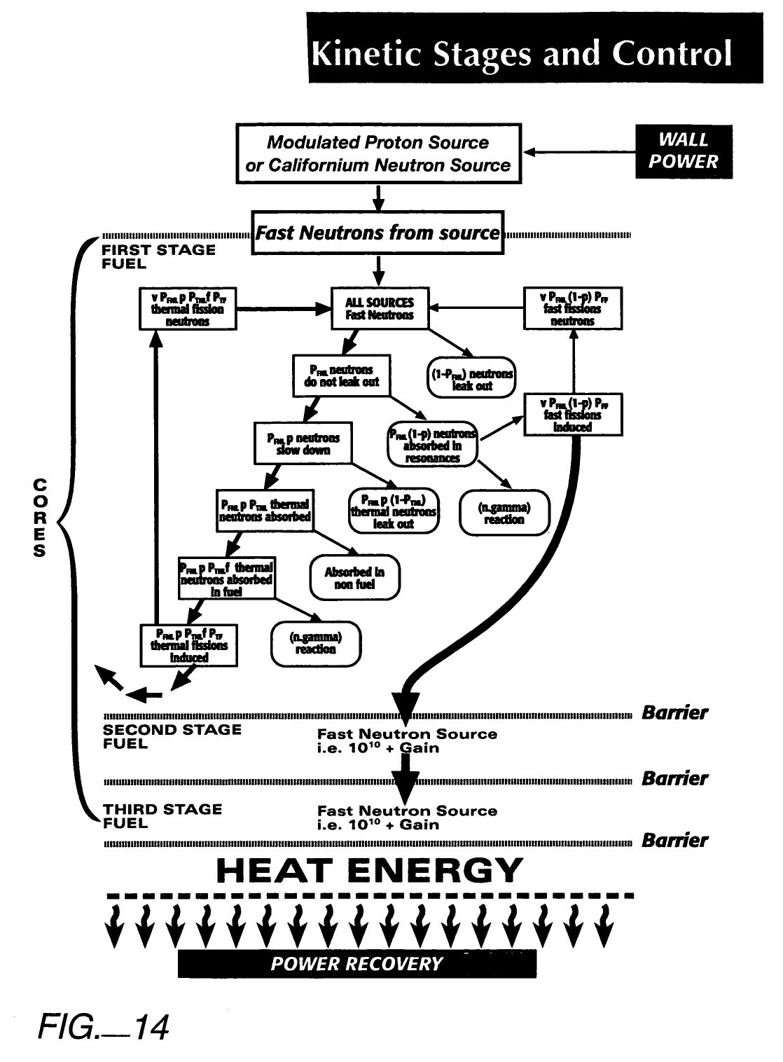

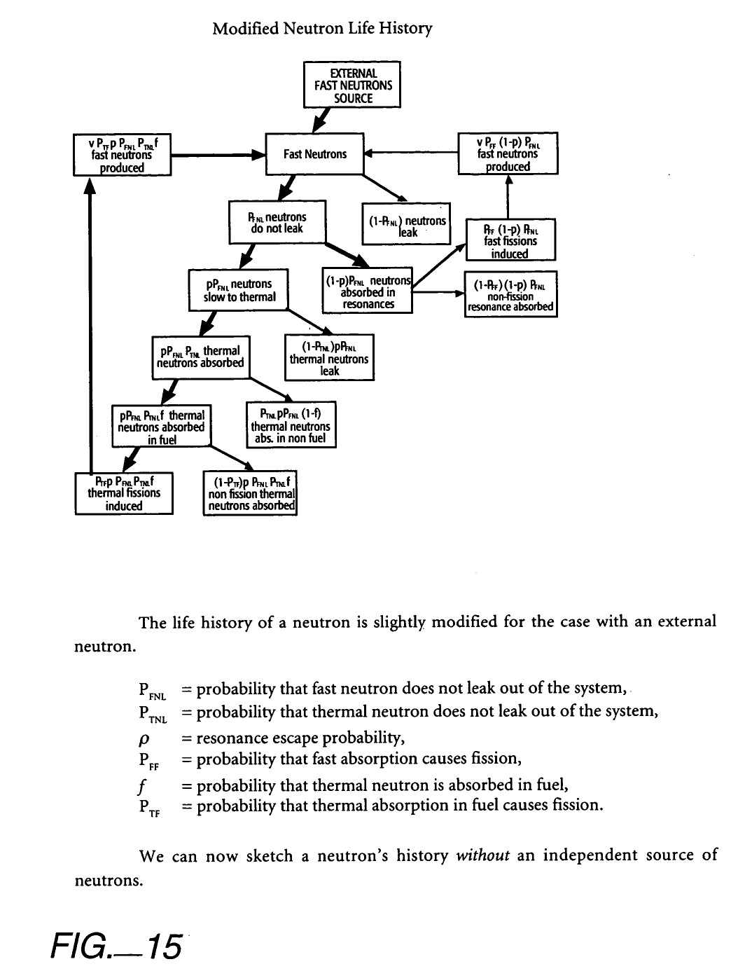

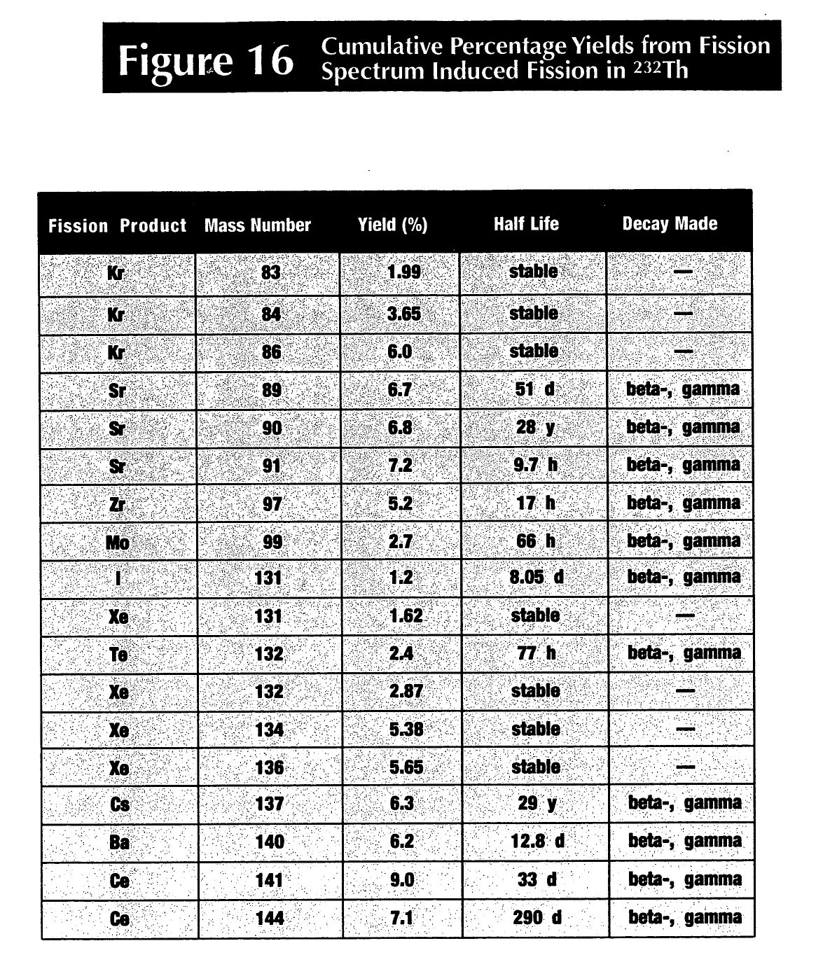

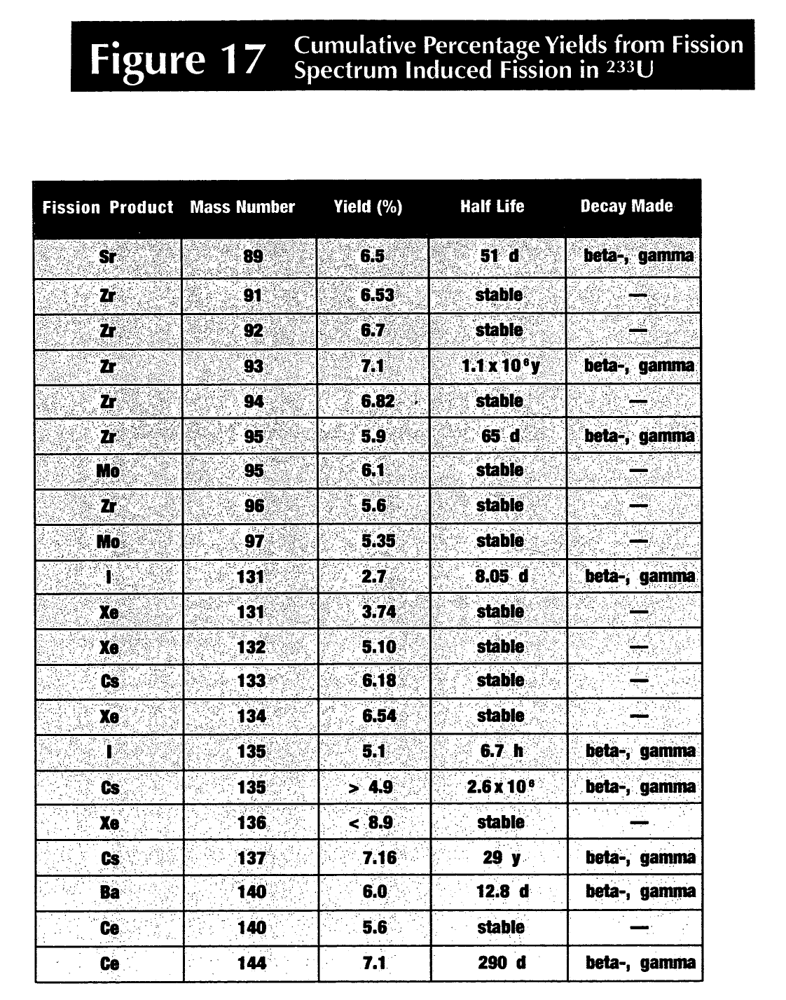

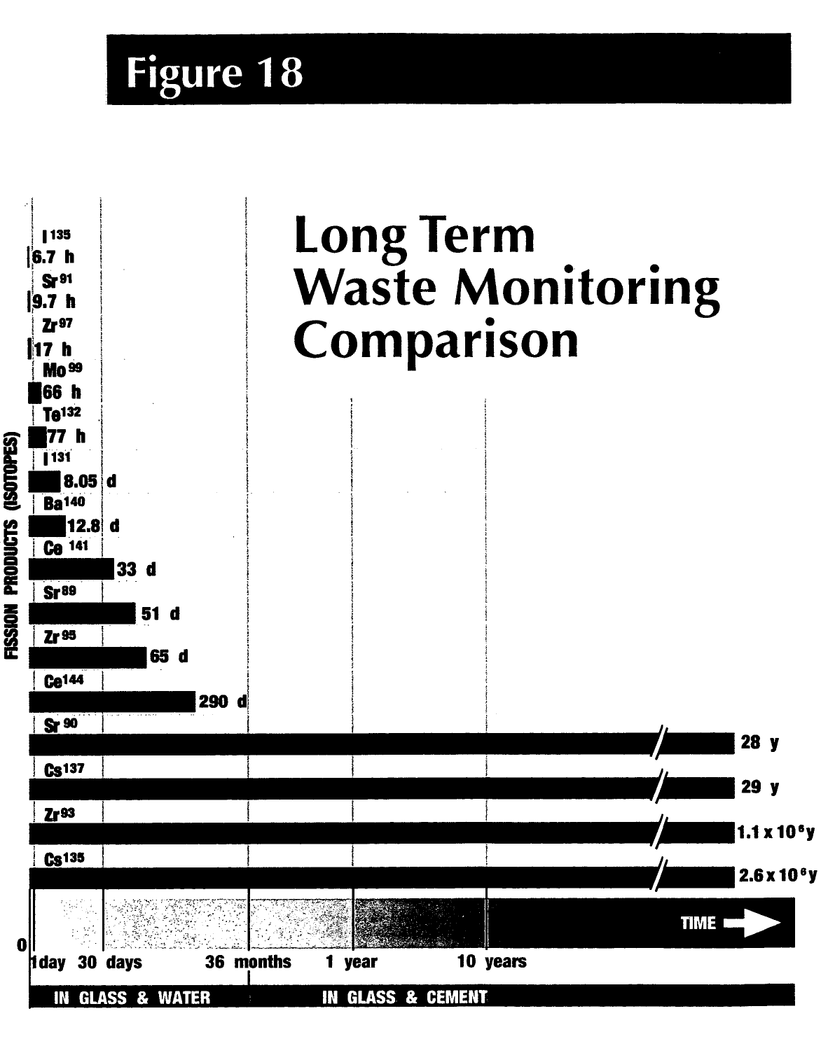

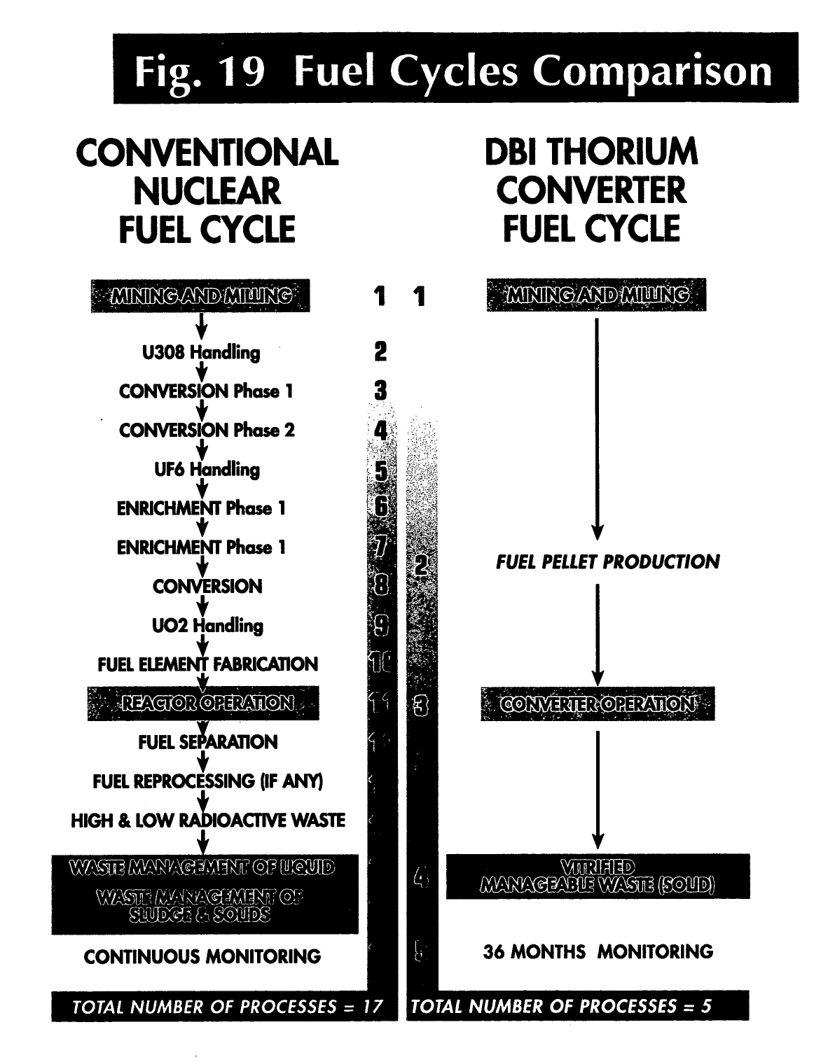

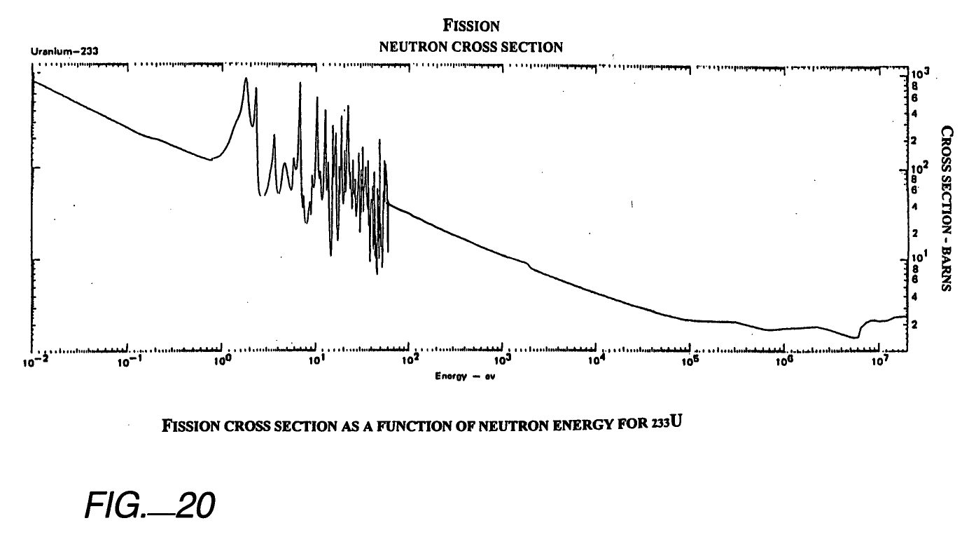

Kinetic Stages and Control. The fundamental idea of the present invention is shown in FIG. 14. The concept could be used now in a single stage, or in the future in multiple stages for larger reactors.

Cavity Assembly with Center Source. Initially only four sets of the cavities (wells 27, 46) hold fuel, each a different amount. Fuel from the primary cavity (e.g., shown in FIG. 10) will be moved to empty wells 27, 47 as new fuel stack assemblies 51 are added. When all cavities are occupied, the cavity holding the least amount of fuel should have a burn-up of about 90% when it is removed for disposal (FIG. 9 and FIG. 10).

Fuel Mining and Milling. The reactor of the present invention involves only scooping thorium-rich monazite sand on to a conveyor belt leading to a 12×12×40-foot trailer, where the thorium is separated out mechanically, within a water environment to prevent the creation of dust tailings. No further conversion or enrichment is necessary; the thorium separated is already a useable fuel. The thorium is then mixed homogeneously with glass and other elements, and pre-baked to produce fuel disks that are placed directly into the reactor core. Any particles created which might be dangerous are vitrified in situ to prevent their exposure to the environment. The fuel cycle of the present invention uses only 1/100 of the energy to produce its fuel pellet that conventional reactor systems use for the processing of uranium fuel.

Temperature Control. The reactor of the present invention receives the fertile ²³²Th, then introduces a controlled number of neutrons from outside the system to convert the thorium isotope into fissile 233U (not found in nature). ²³³U has the smallest fission cross section and the second lowest v, yet has the largest n and thus the best prospect for breeding. The reaction is obtained during modulated neutron injection from either californium or a linear accelerator. When the accelerator pulse is on, heat will rise accordingly. When the accelerator pulse is off, the pile will go below k=1. The on/off intervals should maintain an average core temperature of 1,800° F. if a Rankine cycle is used, and a corresponding 406° F. saturated temperature is chosen. The heat transfer temperature of 900° F. will produce superheated steam at 700° F. The present invention is designed to be monitored by on-site personnel and a state-of-the-art satellite system; therefore if any anomaly occurs, the neutrons can be turned off (or the reactor instantly shut down) either manually or electronically from the remote monitoring site.

Peak Fuel Temperatures & Criticality. The operating temperature of the reactor assembly 60 of the present invention is 926° C. (1700° F.). Sensors note any rise in temperature of 85° C. or more and immediately shut off the supply of neutrons by rotating the emitter drums 24. In the extreme case that the neutron source 24 fails to shut off, gravity feed emergency neutron absorption shutdown rods 52 are inserted into the core well 32. All the monitoring and safety procedures can also be done manually in a matter of seconds. If the fuel temperature had some way to soar to 1,760° C., the thorium would melt but still be contained inside the glass, whose melting point is about 2,700° C. The present invention is a subcritical system, but three back-up systems manage any temperature rise above 85° C. In the extreme condition where all sensors ceased to operate, the discriminator will note it and the system will be shut down automatically or can be shut down manually. Also, under normal operating conditions the reactor of the present invention creates its own temperature ceiling. A high temperature causes the cross-section of thorium to decrease, thus decreasing the reactivity. As soon as the reactivity decreases, temperature decreases. As temperature decreases, the cross-section increases. And so the machine will be able to stabilize itself.

Waste Production. In the reactor of the present invention, the continuous removal of xenon buildup is performed by the injection of helium or other suitable element, thus preventing the “poison” from polluting the fuel. The ongoing xenon removal, together with the ability to move fuel from well to well, allows the reactor to achieve a high fuel burn-up of about 90%. The high fuel burn-up means the total amount of waste produced is only about 10% of what conventional reactors produce and is all low-level. Since the fuel element 11 of the present invention is baked prior to its use in the reactor, the derivatives of the reaction will be held together encapsulated in the glass (FIG. 2C). The low volume of fissile material requires only 36 months of monitoring in water. The remaining isotopes—also vitrified in situ—remain encapsulated during their entire decay process. The solid vitrified fuel disks can then be stored unmonitored in any chosen site.

Materials Safeguard. The subcritical assembly of the present invention avoids threat of nuclear meltdown. The ²³²Th/²³³U cycle does not produce any weapons-grade material, and the amount of fissile fuel existing in the spent fuel disks would be too low to be of any practical use. Radiation safety from the reactor of the present invention is relatively simple. Gamma emissions from thorium derivatives provide a level of public protection, since those isotopes can be easily spotted by modern sensing equipment.

Shielding Materials. The shielding of the reactor assembly 60 meets the demand of neutron energies and gamma emissions. Also, the metallurgy and material selection throughout the core, and the power recovery, whether the media embraces a gas-to-water heat exchanger to produce super-heated steam, or for the steam to be used directly for the production of hydrogen or in a Rankine Cycle for the production of electricity can be those conventionally applied.

### In Summary

(1) The Present Invention. The present invention is a nuclear-powered plant with a confinement section where the reaction takes place in a core having a reactive ²³²Th/²³³U composition, and where an external neutron source-either a linear accelerator or californium—is used as a modulated neutron multiplier for the reactor core output. The core is housed in a containment structure that radiates thermal energy captured in a multiple-paths heat exchanger embedded in a heat transfer media. The exchanger heat energy output is put to use in a conventional gas-to-water heat exchanger to produce commercial quality steam, in one configuration.

(2) Fuel Cycle. The fuel system and cycle are the most prominent part of this invention. Thorium can be easily mined then mixed with glass and pre-baked into a vitrified fuel element disk 11, all mechanically and with no hazardous byproducts. This fuel disk 11 can then be placed directly into the reactor core, with no further conversion. No need exists for complex mining, preprocessed fuel enrichment, complex fuel packaging or transportation, or division of waste disposal.

(3) High Fuel Efficiency. The reactor of the present invention allows—for the first time in history—the fuel to remain in the reactor until the majority of the fertile material has been converted into fissile material and consequently burned up to about 90%. Thorium used in the reactor of the present invention can fuel the United States for about 275 years.

(4) Low Waste Production. The high burn-up, along with the simple fuel processing cycle, means that the volume of waste production is only about 10% of the volume generated by conventional reactors. The waste is low level and encapsulated in glass, where 250 years worth of waste generated by the reactor of the present invention could fill a site only one-fourth the size of the proposed Yucca Mountain repository.

(5) Environmental Impact. The fuel, as well as the core and containment vessel, is of such a detailed design that it can be operated without fear of radioactive proliferation or residual nuclear waste disposal problems.

(6) Weapons Proliferation. The ²³²Th fuel goes through a transmutation to ²³³U, and never produces any weapons grade material.

(7) Photoneutron Activation. The system design is to be compatible with the photoneutron gun that is being designed to bombard the thorium with free neutrons to shift the fertile ²³²Th into man-made fissile ²³³U. This design allows the construction of the entire reactor system without special equipment in a benign state, the shipping of the system to its final destination, and the commissioning and decommissioning of it at will.

1. A nuclear-powered plant assembly comprising:
a nuclear core;
one or more confinement sections confining the nuclear core; and
a fuel source including thorium-232/uranium-233, positioned in the nuclear core, to create a nuclear reaction.

2. The nuclear-powered plant assembly as defined in claim 1, further including:
tank arrangement containing a material suitable for thermalization of neutrons.

3. A nuclear-powered plant assembly comprising:
a nuclear core defining a plurality of fuel wells spaced-apart about said core, each said fuel well adapted for receipt of a nuclear fuel assembly; and
a neutron barrier surrounding the plurality of fuel wells, and configured to enable the passage of fast neutrons (about equal to or above 1-MeV), while preventing the passage of thermal neutrons (below 1-MeV), therethrough.

4. A directional neutron source apparatus for modulating neutrons toward a center core of a nuclear reactor comprising:
a source assembly including a body containing a neutron source material, and a shield device adjacent said body, configured to substantially prevent the passage of neutrons on one side of said body; and
a modulator adapted to selectively modulate the neutrons emitted from the neutron source toward the center core.

5. The directional neutron source assembly as defined in claim 4, wherein
the modulator includes a positioning assembly adapted to position an unshielded side of said body toward and away from the center core of the reactor.

6. The directional neutron source assembly as defined in claim 4, wherein
the modulator includes an assembly adapted to selectively modulate the emission of neutrons from the neutron source material.

7. The directional neutron source assembly as defined in claim 6, wherein
the modulator assembly includes a source driver adapted to selectively position the neutron source material for optimal modulation emission.

8. A fuel assembly for a nuclear reactor comprising:
a retrievable fuel source containing a fissile material including a homogeneous mixture of thorium and glass.

9. The fuel assembly as defined in claim 8, wherein
said homogeneous mixture includes about 50% SiO₂, about 47% ²³²ThO₂, and about 3% ²³³U.

10. The fuel assembly as defined in claim 8, wherein:
said fissile material is embedded in a plurality of stacked fuel disks.

11. The fuel assembly as defined in claim 10, further including:
one or more separators inserted between the fuel disks in a spaced manner to function as reaction poison.

12. A heat transfer assembly for a nuclear reactor having a heat source comprising:
a heat extraction assembly including a plurality of boilers strategically positioned the heat source in a manner extracting heat from said heat source.

13. The heat transfer assembly as defined in claim 12, wherein
said heat extraction assembly is configured to extract heat through conduction.

14. A heat transfer assembly for a neutron source nuclear for a nuclear reactor comprising:
a heat extraction assembly including a plurality of tube members strategically positioned the neutron source for protection there from reaching an excess temperature.

15. A metal enclosure assembly for a nuclear reactor comprising:
a metal enclosure defining an interior cavity formed and dimensioned for receipt of the nuclear reactor therein; and
a primary shielding material substantially surrounding the nuclear reactor that substantially absorbs neutrons emitted from said nuclear reactor.

16. The metal enclosure assembly as defined in claim 15, wherein
said primary shielding material is selected from one of lead, steel and born.

17. A fuel array assembly for a nuclear reactor including a reactor core comprising:
a plurality of fuel assemblies spaced apart about the reactor core;
a modulating neutron source assembly including a neutron source contained within a neutron-absorbing drum adapted enable the passage of fast neutrons (about equal to or above 1-MeV);
wherein said modulated neutron source assembly is disposed proximate a center of the fuel assemblies.

18. A fuel array assembly for a nuclear reactor including a reactor core comprising:
a plurality of fuel assemblies spaced apart about the reactor core;
a first modulating neutron source assembly including a neutron source contained within a neutron-absorbing drum adapted enable the passage of fast neutrons (about equal to or above 1-MeV) therethrough;
a second modulating neutron source assembly including a neutron source contained within a neutron-absorbing drum adapted enable the passage of fast neutrons (about equal to or above 1-MeV) therethrough; and
wherein said first modulated neutron source assembly is disposed proximate one side of the fuel assemblies, and said second modulated neutron source assembly is disposed proximate an opposite side of the fuel assemblies.

19. A fuel element composition for a nuclear reactor comprising:
about 50% SiO₂,;
about 47% ²³²ThO₂; and
about 3% ²³³UO₂, wherein,
said composition is pre-baked at about 2200° F. for about 10 minutes, and wherein
said baking (melting) time is a function of the fuel element thickness.

20. A method of fueling a nuclear reactor containing a plurality of wells each configured for receipt of a nuclear fuel assembly, and contained in a thermal neutron region thereof, said method comprising:
positioning a first fuel assembly, having a charge, in a primary well of the reactor;
irradiating the first fuel assembly in the primary well with neutrons from a neutron source for the production of vast fissile uranium-233;
when the charge of the first fuel assembly declines, switching the first fuel assembly from the primary well to a first empty well; and
placing a second fuel assembly in the primary well, wherein,
said fuel in each fuel assembly is substantially exhausted, removing weapons grade material from the waste stream.
